(19) United States
(12) Patent Application Publication
(10) Pub. No.: US 2008/0175186 A1
(43) Pub. Date: Jul. 24, 2008

(54) METHOD AND SYSTEM FOR DATA TRANSMISSION UNIT RETRANSMISSION, DATA RECEIVER AND DATA TRANSMITTER

(75) Inventors: Juejun Liu, Shenzhen (CN); Jianmin Lu, Shenzhen (CN); Daozhong Zhang, Shenzhen (CN)

Correspondence Address: DARBY & DARBY P.C., P.O. BOX 770, Church Street Station, New York, NY, 10008-0770, US

(73) Assignee: Huawei Technologies Co., Ltd., Shenzhen (CN)

(21) Appl. No.: 12/045,462

(22) Filed: Mar. 10, 2008

Related U.S. Application Data
(63) Continuation of application No. PCT/CN2006/001962, filed on Aug. 4, 2006.

(30) Foreign Application Priority Data
Sep. 8, 2005 (CN) 200510098469.4

(51) Int. Cl. H04B 7/216

(52) U.S. Cl. 370/320

(57) ABSTRACT

A method and system for data transmission unit retransmission between a data receiver and a data transmitter. A data receiver determines that there is a missing data transmission unit based on a non-acknowledgement mechanism. The data receiver transmits identification information of correctly received data transmission units which are in the same link as the missing data transmission unit to a data transmitter. The data transmitter determines a data transmission unit which needs data retransmission according to the identification information it has received, and retransmits the data transmission unit. The method simplifies the detection procedure in which the data receiver detects a missing data transmission unit, simplifies the message content transmitted between the data receiver and the data transmitter, and decreases the length of control message, thereby increasing the response speed of the data receiver to the missing data transmission unit, the retransmission efficiency of the data transmission unit, and payload transmission efficiency in a multilink system.

### CROSS REFERENCE TO RELATED APPLICATIONS

This application is a continuation of International Patent Application No. PCT/CN2006/001962, filed on Aug. 4, 2006, which claims priority from Chinese Patent Application No. 200510098469.4, filed on Sep. 8, 2005, each of which is hereby incorporated by reference in its entirety herein.

### FIELD OF THE INVENTION

The present invention relates to the field of communication technologies, and particularly to a method and system for data transmission unit retransmission, a data transmitter and a data receiver.

### BACKGROUND OF THE INVENTION

Today, 3G mobile communication technologies are matured and applied commercially gradually, and 3GPP2's CDMA2000 1XEV-DO (Evolution, Data Only) will further provide competent wireless access systems in the years to come.

1XEV-DO is a technique designed to transmit high-speed packet data traffic, with the carrier of each sector supporting a peak rate of up to 2.4 Mbps; and in Rev.A, the peak rate is up to 3.1 Mbps. However, to keep competitiveness in a decade or decades in the future, new wireless access techniques have to be introduced.

At present, the industry has reached a preliminary agreement on the evolution of 3GPP2's air interface technique, i.e. dividing the evolution of 3GPP2's air interface technique into two phases. During phase 1: with the multi-carrier DO technique, a higher peak rate is to be obtained and backward compatibility is to be ensured, by means of software upgrade at upper layers, on the premise of not modifying the physical layer; it is expected that the standard will be completed by the end of 2005. During phase 2: more new leading techniques are to be introduced, which is a long term of 3GPP2 evolution program.

Radio Link Protocol (RLP), as a link layer protocol for best-effort transmission of packet data in a 1XEV-DO system, can provide more reliable data transmission for upper layers, such as the Transmission Control Protocol (TCP) layer, and thereby prevent burst error code interferences from the wireless side.

RLP is a protocol that provides error detection and data frame retransmission based on Non-Acknowledgement (NAK). Upon detecting a data frame loss in the transmission process, the data receiver requests, via a NAK control message, the data transmitter to retransmit the missing data frame. The data transmitter retransmits the data according to the sequence number of the first byte of the missing data and the length of the missing data carried in the NAK control message.

In a multi-carrier DO system, it is possible that multiple forward carrier channels transmit data frames simultaneously; therefore, RLP has to be modified to ensure effectiveness and reliability of data receiving.

A schematic diagram illustrating a method for retransmission of data frames based on a single-RLP instance in the prior art is shown in FIG. 1.

As shown in FIG. 1, the network side maintains a single-RLP instance. The single-RLP instance packs upper layer packet data and assigns a consecutive SAR_Seq (SAR means Segmentation and Reassembly Protocol) sequence number to each RLP packet, and distributes the RLP packets with consecutive SAR_Seq sequence numbers to different carrier links for transmission. Each carrier link assigns a consecutive ARQ_Seq (ARQ means Automatic Retransmission Request) sequence number to the RLP packets transmitted thereon.

The wireless access terminal detects whether there is any missing frame on the carrier link according to the consecutiveness of ARQ_Seq sequence numbers of the RLP packets. The SAR_Seq sequence numbers of the RLP packets are used to reorder the RLP packets received from the multiple carrier links, so as to submit them to the upper layers for processing.

If the wireless access terminal detects the ARQ_Seq sequence numbers on a carrier link are not consecutive, it is indicated there is a missing frame on the carrier link. The wireless access terminal requests, via a NAK control message, the network side to retransmit the RLP packets involving the missing frame.

The NAK based data frame retransmission method in an existing multi-carrier DO system is described as follows in detail in conjunction with two examples.

### EXAMPLE 1

The wireless access terminal receives from carrier link 1 and carrier link 2 SAR_Seq sequence numbers and ARQ_Seq sequence numbers of RLP packets as follows:

| Carrier link 1, i.e. Link 1 | Carrier link 2, i.e. Link 2 |
|---|---|
| <ARQ_Seq, SAR_Seq> | <ARQ_Seq, SAR_Seq> |
| <1,5> --Received correctly | <1,6> --Received correctly |
| | <2,8> -- Not received yet |
| <3,9> --Received correctly | <3,10> -- Not received yet |

The ARQ_Seq sequence numbers of RLP packets received by the wireless access terminal from carrier link 1 are 1 and 3, and the ARQ_Seq sequence number of an RLP packet received by the wireless access terminal from carrier link 2 is 1. Because the ARQ_Seq sequence numbers of the RLP packets from carrier link 1 are not consecutive, the wireless access terminal detects there is a missing frame, and requests the network side to retransmit the RLP packet.

When determining there is an RLP packet needed to be retransmitted, the wireless access terminal further determines the SAR_Seq sequence number of the missing RLP packet. The wireless access terminal usually determines the SAR_Seq sequence number of the missing RLP packet with the following method.

The wireless access terminal determines the SAR_Seq sequence numbers of the last RLP packets received from the two carrier links are 6 and 9; therefore, the wireless access terminal determines the SAR_Seq sequence numbers of the missing RLP packets are 7 and 8, although the RLP packet with the SAR_Seq sequence number of 8 may be still transmitted in air.

After having determined the SAR_Seq sequence numbers of the missing RLP packets, the wireless access terminal assembles and sends a NAK control message to the network side. The NAK control message needs to contain the following information: the SAR_Seq sequence numbers, 7 and 8, of the missing RLP packets, the SAR_Seq sequence number, 9, of the last RLP packet received by the wireless access terminal from carrier link 1 and the SAR_Seq sequence number, 6, of the last RLP packet received by the wireless access terminal from carrier link 2.

Upon receiving the NAK control message, the access network determines the carrier links on which the missing RLP packets are transmitted, according to a list kept locally. For example, the network side determines the RLP packet with the SAR_Seq sequence number of 7 is transmitted on carrier link 1, while the RLP packet with the SAR_Seq sequence number of 8 is transmitted on carrier link 2. Depending on the SAR_Seq sequence number, 9, of the last RLP packet received from carrier link 1 provided in the NAK control message, the network side determines the RLP packet with the SAR_Seq sequence number of 7 is a missing frame and has to be retransmitted; and depending on the SAR_Seq sequence number, 6, of the last RLP packet received from carrier link 2 provided in the NAK control message, the network side determines the RLP packet with the SAR_Seq sequence number of 8 has not been received yet and is not a missing frame, and thereby does not need to be retransmitted.

After having determined the RLP packet needed to be retransmitted, the network side retransmits the RLP packet with the SAR_Seq sequence number of 7 to the wireless access terminal. The challenge regarding stable forward data transmission based on RLP in a multi-carrier DO system is thus overcome.

### EXAMPLE 2

The wireless access terminal receives from carrier link 1 and carrier link 2 SAR_Seq sequence numbers and ARQ_Seq sequence numbers of RLP packets as follows:

| Carrier link 1, i.e. Link 1 | Carrier link 2, i.e. Link 2 |
|---|---|
| <ARQ_Seq, SAR_Seq> | <ARQ_Seq, SAR_Seq> |
| <1,5> -- Received correctly | <1,6> -- Received correctly |
| <2,7> -- Received correctly | |
| <3,8> -- Received correctly | |
| | <2,10> -- Received correctly |
| <5,11>--Received correctly | <3,12> -- Not received yet |

The ARQ_Seq sequence numbers of RLP packets received by the wireless access terminal from carrier link 1 are 1, 2, 3, and 5, and the ARQ_Seq sequence numbers of RLP packets received by the wireless access terminal from carrier link 2 are 1, 2, and 3. Because the ARQ_Seq sequence numbers of the RLP packets from carrier link 1 are not consecutive, the wireless access terminal detects there is a missing frame, and requests the network side to retransmit the RLP packet.

When determining there is an RLP packet needed to be retransmitted, the wireless access terminal further determines the SAR_Seq sequence number of the missing RLP packet. The wireless access terminal determines the SAR_Seq sequence numbers of the last RLP packets received from the two carrier links are 10 and 11, and the RLP packet with a SAR_Seq sequence number of 8 is received correctly; therefore, the wireless access terminal determines the SAR_Seq sequence number of the missing RLP packet is 9.

After having determined the SAR_Seq sequence number of the missing RLP packet, the wireless access terminal assembles and sends a NAK control message to the network side. The NAK control message needs to contain the following information: the SAR_Seq sequence number, 9, of the missing RLP packet; the SAR_Seq sequence number, 11, of the last RLP packet received by the wireless access terminal from carrier link 1; and the SAR_Seq sequence number, 10, of the last RLP packet received by the wireless access terminal from carrier link 2.

Upon receiving the NAK control message, the network side determines the carrier links on which the missing RLP packets are transmitted, according to a list kept locally. For example, the network side determines the RLP packet with the SAR_Seq sequence number of 9 is transmitted on carrier link 1. Depending on the SAR_Seq sequence number, 11, of the last RLP packet received from carrier link 1 provided in the NAK control message, the network side determines the RLP packet with the SAR_Seq sequence number of 9 is a missing frame and has to be retransmitted.

After having determined the RLP packet needed to be retransmitted, the network side retransmits the RLP packet with the SAR_Seq sequence number of 9 to the wireless access terminal. The challenge regarding stable forward data transmission based on RLP in a multi-carrier DO system is overcome.

It can be seen from the above that, in the existing NAK-based data frame retransmission method, the terminal has to determine the missing frames according to the RLP packets received from multiple carrier links. If there is a large number of forward carrier links, such a method will severely increase the complexity in judgment of missing data frames by the wireless access terminal. As a result, the wireless access terminal may be unable to make response quickly to the loss of data frames. Furthermore, the NAK control message assembled by the wireless access terminal carries the SAR_Seq sequence numbers of the last RLP packets received from the carrier links, and thus the length of the NAK control message is in proportional to the number of carrier links. In practical applications, a SAR_Seq sequence number is usually of 22 bits. As the number of carrier links increases, the length of the NAK control message increases severely and therefore the efficiency of payload transmission and the data throughput will be degraded.

### SUMMARY OF THE INVENTION

The present invention provides a data transmission unit retransmission method and system, a data transmitter, and a data receiver, thereby simplifying the process of missing data transmission unit detection at the data receiver, simplifying the contents of the message transmitted between the data receiver and the data transmitter, and improving the speed of the response of the data transmitter to missing data transmission units, the efficiency of the data transmission unit retransmission and the efficiency of payload transmission in a multi-link system.

In view of the above, the present invention provides a method for data transmission unit retransmission, including the steps of:

A. in the case of multiple links, determining, by a data receiver, that there is a Non-Acknowledgement-based missing data transmission unit;
B. transmitting, by the data receiver, identification information of data transmission units that have been received correctly from a link on which the missing data transmission unit is transmitted, to a data transmitter; and
C. determining, by the data transmitter, the data transmission unit needed to be retransmitted according to the received identification information, and retransmitting the data transmission unit needed to be retransmitted.

The following technical solutions of the method are optional.

The multiple links are multiple physical links or logical links.

The multiple links are links applied in a wireless communication environment or wired communication environment.

The multiple links are multiple carriers in a CDMA 2000 system.

The step A may include the steps of:

upon detecting that sequence numbers of data transmission units received from a single link are inconsecutive, determining, by the data receiver, that the Non-Acknowledgement-based missing data transmission unit occurs.

In the step B, the data transmission units that have been received correctly are two non-retransmitted data transmission units that have been received correctly when the missing data transmission unit is detected, one being a non-retransmitted data transmission unit of a penultimately received non-retransmitted data packet and having a largest SAR sequence number among all non-retransmitted data transmission units of the penultimately received non-retransmitted data packet, and the other being a non-retransmitted data transmission unit of a last received non-retransmitted data packet and having a smallest SAR sequence number among all non-retransmitted data transmission units of the last received non-retransmitted data packet.

The identification information of the data transmission units is: sequence numbers assigned by the data transmitter, wherein the data transmitter assigns a consecutive sequence number for each of all data transmission units transmitted on all the links to the data receiver.

The step B may include the steps of:

assembling, by the data receiver, a control message according to the identification information of the data transmission units received correctly, and transmitting the control message to the data transmitter, to request the data transmitter to retransmit the missing data transmission unit.

The step C may include the steps of:

C1. determining, by the data transmitter, link identification information in an entry of a data transmission unit sending list matching the identification information of received data; transmission units, and taking the link identification information as the identification information of a link on which the missing data transmission unit is transmitted; and
C2. determining, by the data transmitter, the data transmission unit needed to be retransmitted according to the data transmission unit sending list, the identification information of the link on which the missing data transmission unit is transmitted, and the received identification information of the data transmission units.

The step C2 may include the steps of:

determining, by the data transmitter, the identification information of the missing data transmission unit according to the received identification information of the data transmission units;
determining, by the data transmitter, the link identification information in the entry of the data transmission unit sending list matching the received identification information of the data transmission units, and judging whether the link identification information in the matching entry is identical to the identification information of the link on which the missing data transmission unit is transmitted;
if the link identification information in the matching entry is identical to the identification information of the link on which the missing data transmission unit is transmitted, determining, by the data transmitter, the missing data transmission unit is the data transmission unit needed to be retransmitted, and retransmitting the data transmission unit needed to be retransmitted; and
if the link identification information in the matching entry is not identical to the identification information of the link on which the missing data transmission unit is transmitted, determining, by the data transmitter, the missing data transmission unit does not need to be retransmitted.

The present invention provides a system for data transmission unit retransmission, including: a data receiver and a data transmitter, wherein the data receiver has a retransmission request unit and the data transmitter has a retransmission unit, wherein

the retransmission request unit is configured to determine, upon determining occurrence of a Non-Acknowledgement-based missing data transmission unit, identification information of data transmission units that have been received correctly from a link on which the missing data transmission unit is transmitted and transmit the identification information of the data transmission units received correctly to the data transmission unit retransmission end; and
the retransmission unit is configured to determine a data transmission unit needed to be retransmitted according to the received identification information and retransmit the data transmission unit needed to be retransmitted to the retransmission request end.

The retransmission request unit includes: a detection module, an identification information determination module, and a control message assembly module; and wherein the retransmission unit includes: a data transmission unit retransmission determination module and a retransmission module; wherein

the detection module is configured to detect sequence numbers of data transmission units received by the data receiver from a single link, determine, upon determining that the data transmission unit sequence numbers assigned by the link are inconsecutive, the Non-Acknowledgement-based missing data transmission unit and notify the identification information determination module;
the identification information determination module is configured to determine, upon receiving the notification from the detection module, data transmission unit sequence numbers of two non-retransmitted data transmission units that, when the missing data transmission unit is detected, have been received correctly by the data receiver from the link on which the missing data transmission unit is transmitted, one being a non-retransmitted data transmission unit of a penultimately received non-retransmitted data packet and having a largest SAR sequence number among all non-retransmitted data transmission units of the penultimately received non-retransmitted data packet, and the other being a non-retransmitted data transmission unit of a last received non-retransmitted data packet and having a smallest SAR sequence number among all non-retransmitted data transmission units of the last received non-retransmitted data packet, and transmit the data transmission unit sequence numbers of the two non-transmitted data transmission units to the control message assembly module;
the control message assembly module is configured to assemble a control message according to the data transmission unit sequence numbers of the two received non-retransmitted data transmission units, and transmit the control message to the data transmission unit retransmission determination module;
the data transmission unit retransmission determination module is configured to determine link identification information in an entry of a data transmission unit sending list stored locally matching the received data transmission unit sequence number, determine the data transmission unit needed to be retransmitted according to the data transmission unit sending list, the link identification information, and the received identification information of the non-retransmitted data transmission units, and transmit the data transmission unit sequence number of the data transmission unit needed to be retransmitted to the retransmission module; and
the retransmission module is configured to transmit the corresponding data transmission unit to the data receiver according to the received data transmission unit sequence number.

The present invention may provide a data receiver including a retransmission request unit that the retransmission request unit is configured to determine, upon determining occurrence of a Non-Acknowledgement-based missing data transmission unit, identification information of data transmission units that have been received correctly from a link on which the missing data transmission unit is transmitted, and transmit the identification information of the data transmission units received correctly to a data transmitter so that the data transmitter can determine a data transmission unit needed to be retransmitted according to the identification information.

The present invention may also provide a data transmitter including a retransmission unit that the retransmission unit is configured to determine a data transmission unit needed to be retransmitted according to identification information transmitted from a data receiver and retransmit the data transmission unit needed to be retransmitted to the data receiver; where

the identification information is that of the data transmission units that have been received correctly from the link on which the missing data transmission unit is transmitted.

It can be seen from the above technical solutions that, in the present invention, when it is determined there is a missing data transmission unit, the data receiver does not need to judge the receiving of data transmission units from other links, but can directly obtain the identification information of data transmission units that have been received correctly from the link on which the missing data transmission unit is transmitted. As a result, the process of missing data transmission unit detection by the data receiver is simplified greatly. The identification information, e.g. sequence numbers, of two of non-retransmitted data transmission units (one being a non-retransmitted data transmission unit of a penultimately received non-retransmitted data packet and having a largest SAR sequence number among all non-retransmitted data transmission units of the penultimately received non-retransmitted data packet, and the other being a non-retransmitted data transmission unit of a last received non-retransmitted data packet and having a smallest SAR sequence number among all non-retransmitted data transmission units of the last received non-retransmitted data packet) that have been received correctly by the data receiver from the link on which the missing data transmission unit is transmitted, is transmitted to the data transmitter, and the data transmitter compares the received data transmission unit identification information with the entries of a data transmission unit sending list and thereby obtains the identification information of the link on which the missing data transmission unit is transmitted, and determines the data transmission unit needed to be retransmitted according to the data transmission unit sending list, the identification information of the data transmission units received correctly, and the identification information of the link on which the missing data transmission unit is transmitted. Therefore, without increasing complexity in judgment of the data transmission unit to be transmitted by the data transmitter, the present invention simplifies the contents of the message transmitted between the data receiver and the data transmitter greatly, effectively reduces the length of the control message, e.g. NAK, and makes the length of the control message independent of the number of the links. Consequently, the technical solutions provided in the present invention improves the speed of the response of the data receiver to the missing data transmission unit, the efficiency of the data transmission unit retransmission and the efficiency of payload transmission in a multi-link system.

### BRIEF DESCRIPTION OF THE DRAWINGS

The invention will become more readily apparent from the Detailed Description of the Invention, which proceeds with reference to the following drawings, in which:

FIG. 1 is a schematic diagram illustrating data frame retransmission in the prior art; and

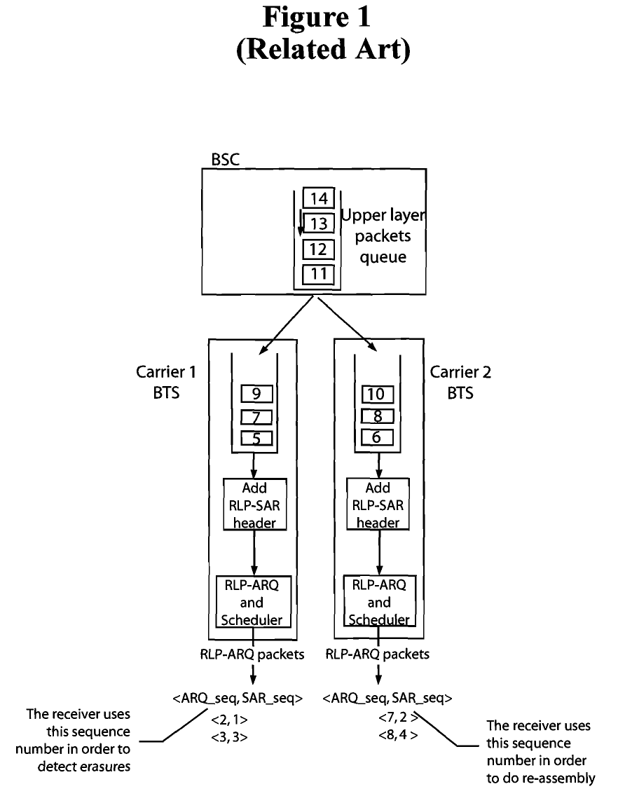

FIG. 2 is a schematic diagram illustrating a system for data transmission unit retransmission according to an embodiment of the present invention.

### DETAILED DESCRIPTION OF THE INVENTION

The core of the method and system provided in the present invention lies in that: in a multi-link environment, the data receiver determines occurrence of a Non-Acknowledgement-based (NAK-based) missing data transmission unit; the data receiver transmits to the data transmitter the identification information of the data transmission units received correctly from the link on which the missing data transmission unit is transmitted; and the data transmitter determines the data transmission unit needed to be retransmitted according to the received identification information, and retransmits the data transmission unit.

The technical solutions provided in the present invention are further described on the basis of the core ideal of the present invention.

The multiple links described in the present invention may be multiple physical links, such as physical links in a wireless communication environment, and physical links applied in a wired communication environment; or, they may be multiple logical links. For example, in an interlace-based data transmission system, each interlace may be regarded as a logical channel. In that case, the processing for a multi-interlace transmission structure is similar to that for multiple carrier links in a multi-carrier DO system. Likewise, the logical links may be logical links applied in a wireless communication environment or logical links applied in a wired communication environment. In other words, the present invention is applicable to both a wireless communication system and a wired communication system. Interlace is used more widely in wireless communication systems, such as DO Rev.A (Rev.A is the version number of the technical protocol), Long Term Evolution (LTE), Air Interface Evolution (AIE, the name of 3GPP2's air interface evolution program), and 802.20 (the name of a wireless broadband access standard).

The data transmission unit described in the present invention may be a data frame, a data packet, a data byte stream, etc., and the missing data transmission unit may be referred to as a missing frame, a missing packet, a missing packet, a missing data byte stream, etc.

The technical solutions provided in the present invention are described as follows in detail in conjunction with a multi-carrier DO system as an example.

In a multi-carrier DO system, the data receiver is a wireless access terminal, the data transmitter is the network side, the data transmission unit is a data frame, and the missing data transmission unit is a missing frame.

A NAK-based data frame transmitted from the network side to the wireless access terminal carries two identifications: one is a consecutive and sequential sequence number assigned by the network side to any data frame to be transmitted to the wireless access terminal (e.g. a SAR_Seq sequence number), and the other is a consecutive and sequential sequence number assigned by each carrier link to a data frame transmitted thereon (i.e. a sequence number for a single carrier link, such as an ARQ_Seq sequence number). For the convenience of description, hereunder the sequence number assigned by the network side to any data frame to be transmitted to the wireless access terminal is referred to as a data frame sequence number, while the sequence number assigned by each carrier link to a data frame transmitted thereon is referred to as a data frame sequence number on carrier link.

The wireless access terminal receives data frames transmitted over all carrier links from the network side, and determines whether there is any NAK-based missing frame on each single carrier link on the basis whether the sequence numbers of the data frames on that link are disordered. In other words, when determining the sequence numbers of the data frames received from a carrier link are not consecutive in that carrier link, the wireless access terminal determines there is a missing frame in that carrier link.

When determining there is a missing frame in a carrier link, the wireless access terminal determines the data frame sequence numbers of two of non-retransmitted data frames that, when the missing frame is detected, have been received correctly from the carrier link on which the missing frame is transmitted, one having a second largest SAR sequence number among all non-retransmitted data frames that have been received correctly, and the other having a largest SAR sequence number. It thus can be seen that, in the present invention, when the wireless access terminal tries to determine the data frame sequence number of the missing frame, it need not refer to the data frame sequence numbers of data frames received from another carrier link; instead, it only needs to determine the data frame sequence numbers of two of non-retransmitted data frames that, when the missing frame is detected, have been received correctly from the carrier link on which the missing frame is transmitted, one having a second largest SAR sequence number among all non-retransmitted data frames that have been received correctly, and the other having a largest SAR sequence number, thus simplifying the processing of a missing frame by the wireless access terminal and improving the speed of the response of the wireless access terminal to the missing frames.

After having determined the data frame sequence numbers of the two non-retransmitted data frames that have been received correctly when the missing frame is detected, the wireless access terminal needs to transmit the two data frame sequence numbers to the network side. For example, the wireless access terminal may make the data frame sequence numbers of the two non-retransmitted data frames carried in a NAK control message to transmit to the network side. In that way, no data frame sequence number of any data frame in another carrier link will be carried in the NAK control message, and the length of the NAK control message is independent of the number of the carrier links, but only depends on the length of data frame sequence number, which, in practical applications, is usually of 22 bits. Therefore, the data frame identification information in the NAK control message always occupies 44 bits, regardless of the number of the carrier links.

It can be seen from the above that, to transmit a NAK control message to the network side, the wireless access terminal need not make the sequence numbers of all of the last data frames received from the carrier links carried in the NAK control message, thus simplifying the NAK control message, shortening the length of the NAK control message, and improving the efficiency of payload transmission in a multi-carrier DO system.

The network side obtains from the received NAK control message the data frame sequence numbers of the two non-retransmitted data frames that have been received correctly when the missing frame is detected, one having a second largest SAR sequence number among all non-retransmitted data frames that have been received correctly, and the other having a largest SAR sequence number, and compares the data frame sequence number of either of the data frames with the entries in the data frame sending list stored locally, to obtain a matching entry. The network side determines the carrier link identification in the matching entry as the identification of the carrier link on which the missing frame is transmitted, determines a data frame sequence number range of the missing frame according to the data frame sequence numbers of the aforementioned two non-retransmitted data frames, and makes an judgment on each data frame in the data frame sequence number range of the missing frame. If the carrier link identification in the data frame sending list corresponding to a data frame in the data frame sequence number range is identical to the carrier link identification of the aforementioned missing frame, the network side determines the data frame is the data frame to be transmitted, i.e. the data frame is right the missing frame. If the carrier link identification in the data frame sending list corresponding to a data frame in the data frame sequence number range is different to the carrier link identification of the missing frame, the network side determines the data frame is transmitted in another carrier link and need not be retransmitted, i.e. the data frame is not the right missing frame.

Of course, instead of determining the data frame sequence number range of the missing frame, the network side may compare the data frame sequence numbers, in the data frame sending list, of the data frames on the carrier link on which the missing frame is transmitted, with the data frame sequence numbers of the two non-retransmitted data frames. In that way, the network side can also determine the data frame needed to be retransmitted.

It can be seen from the above that, in the present invention, the method for determining the data frame sequence number of a missing frame by the wireless access terminal is improved and the information carried in the NAK control message is optimized, without changing the method for judging the data frame needed to be retransmitted by the network side substantially. More importantly, the present invention does not increase the complexity in judgment of the data frame needed to be retransmitted by the network side. As a result, the method provided in the present invention has a wide applicability.

The method provided in the present invention is described as follows in conjunction with the two applications based on the single-RLP NAK mechanism, which have been mentioned in the section Background of the Invention.

### EXAMPLE 3

The wireless access terminal receives from carrier link 1 and carrier link 2 SAR_Seq sequence numbers and ARQ_Seq sequence numbers of RLP packets as follows:

| Carrier link 1, i.e. Link 1 | Carrier link 2, i.e. Link 2 |
|---|---|
| <ARQ_Seq, SAR_Seq> | <ARQ_Seq, SAR_Seq> |
| <1,5> -- Received correctly | <1,6> -- Received correctly |
| | <2,8> -- Not received yet |
| <3,9> -- Received correctly | <3,10> -- Not received yet |

The ARQ_Seq sequence numbers of non-retransmitted. RLP packets received by the wireless access terminal from carrier link 1 are 1 and 3, and the ARQ_Seq sequence numbers of RLP packets received by the wireless access terminal from carrier link 2 are 1, 2, and 3. Because the ARQ_Seq sequence numbers of RLP packets from carrier link 1 are not consecutive, the wireless access terminal detects there is a missing frame, and will request the network side to retransmit the RLP packet.

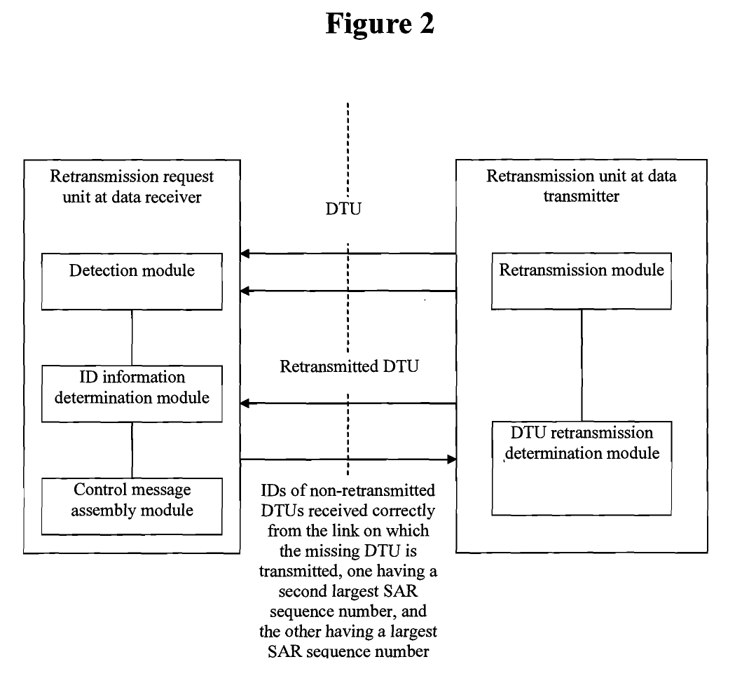

After having determined there is a missing frame and the RLP packet needs to be retransmitted, the wireless access terminal further determines the SAR_Seq sequence numbers of two of RLP data packets that, when the missing frame is detected, have been received correctly by the wireless access terminal from the carrier link on which the missing RLP packet is transmitted, one having a second largest SAR sequence number among all RLP data packets that have been received correctly, and the other having a largest SAR sequence number (see, e.g., FIG. 2). The wireless access terminal determines that the SAR_Seq sequence numbers of the two non-retransmitted RLP packets (one having a second largest SAR sequence number, and the other having a largest SAR sequence number) that are received correctly by the wireless access terminal from carrier link 1 and are immediately before and after the missing RLP packet are 5 and 9.

After having determined the SAR_Seq sequence numbers of the two non-retransmitted RLP packets (one having a second largest SAR sequence number, and the other having a largest SAR sequence number) that, when the missing frame is detected, are received correctly by the wireless access terminal from the carrier link on which the missing frame is transmitted, the wireless access terminal assembles and sends a NAK control message to the network side. The NAK control message needs to contain the following information: the SAR_Seq sequence numbers, 5 and 9, of the two non-retransmitted RLP packets on carrier link 1 (one having a second largest SAR sequence number, and the other having a largest SAR sequence number) that, when the missing frame is detected, have been received by the wireless access terminal correctly.

Upon receiving the NAK control message, the network side determines the SAR_Seq sequence number range of the missing frame is from 6 to 8 according to the SAR_Seq sequence numbers 5 and 9. The network side determines an entry matching the SAR_Seq sequence number 5 or 9 in the RLP packet sending list stored locally, and determines from the entry that the carrier link identification for the missing frame is carrier link 1.

The network side further compares each SAR_Seq sequence number in the SAR_Seq sequence number range of the missing frame with the RLP packet sending list. Because the RLP packets with a SAR_Seq sequence number of 6 and a SAR_Seq sequence number of 8 are transmitted on carrier link 2, the carrier link identifications in the entries matching the SAR_Seq sequence number 6 and 8, respectively, should be the identification of carrier link 2. Therefore, the carrier link identification of the missing frame determined by the network side, i.e. the identification of carrier link 1, is different from the carrier link identification in the entries matching the SAR_Seq sequence number 6 and 8, and the network side determines it need not retransmit the RLP packets with the SAR_Seq sequence number of 6 and the SAR_Seq sequence number of 8. Likewise, because the RLP packet with a SAR_Seq sequence number of 7 is transmitted on carrier link 1, the carrier link identification in the entry matching the SAR_Seq sequence number 7 should be the identification of carrier link 1. Therefore, the carrier link identification of the missing frame determined by the network side, i.e. the identification of carrier link 1, is identical to the carrier link identification in the entry matching the SAR_Seq sequence number 7, and the network side determines the RLP packet with the SAR_Seq sequence number of 7 is the missing frame and should be retransmitted.

After having determined the RLP packet needed to be retransmitted, the network side retransmits the RLP packet with the SAR_Seq sequence number of 7 to the wireless access terminal. As a result, the challenge regarding stable forward data transmission based on RLP in a multi-carrier DO system is overcome.

It can be seen from example 3 that, in the present invention, to assemble the NAK control message, the wireless access terminal need not refer to the SAR_Seq sequence numbers of the RLP packets received from carrier link 2, but only need determine the SAR_Seq sequence numbers of the RLP packets received correctly from carrier link 1. As a result, the processing of a missing frame by the wireless access terminal is simplified. In the prior art, the NAK control message in example 1 contains the following information: the SAR_Seq sequence number, 7, of the missing RLP packet, the SAR_Seq sequence number, 9, of the last RLP packet received by the wireless access terminal from carrier link 1, and the SAR_Seq sequence number, 6, of the last RLP packet received by the wireless access terminal from carrier link 2; while in the present invention, the NAK control message contains the following information: the SAR_Seq sequence numbers, 5 and 9, of the two non-retransmitted RLP packets (one having a second largest SAR sequence number, and the other having a largest SAR sequence number) that, when the missing frame is detected, are received correctly by the wireless access terminal from carrier link 1. A SAR_Seq sequence number usually occupies 22 bits. In example 1 of the prior art, the NAK control message is of at least 66 bits; and in addition, as the number of the carrier links increases, the length of the NAK control message will increase in a unit of 22 bits. However, in the present invention, the NAK control message is of at least 44 bits, and the length is independent to the number of the carrier links. As the result, the technical solution in the present invention simplifies the NAK control message and improves the efficiency of payload transmission in a multi-carrier DO system.

### EXAMPLE 4

The wireless access terminal receives from carrier link 1 and carrier link 2 SAR_Seq sequence numbers and ARQ_Seq sequence numbers of RLP packets as follows:

| Carrier link 1, i.e. Link 1 | Carrier link 2, i.e. Link 2 |
|---|---|
| <ARQ_Seq, SAR_Seq> | <ARQ_Seq, SAR_Seq> |
| <1,5> -- Received correctly | <1,6> -- Received correctly |
| <2,7> -- Received correctly | |
| <3,8> -- Received correctly | |
| | <2,10> -- Received correctly |
| <5,11>-- Received correctly | <3,12> -- Not received yet |

The ARQ_Seq sequence numbers of RLP packets received by the wireless access terminal from carrier link 1 are 1, 2, 3, and 5, and the ARQ_Seq sequence numbers of RLP packets received by the wireless access terminal from carrier link 2 are 1, 2, and 3. Because the ARQ_Seq sequence numbers of the RLP packets on carrier link 1 are not consecutive, the wireless access terminal detects there is a missing frame, and will request the network side to retransmit the RLP packet. Upon determining there is an RLP packet needed to be retransmitted, the wireless access terminal further determines the SAR_Seq sequence numbers of two of non-retransmitted RLP packets that have been received correctly by the wireless access terminal when the missing frame is detected, one having a second largest SAR sequence number among all non-retransmitted RLP data packets that have been received correctly, and the other having a largest SAR sequence number. The wireless access terminal determines the SAR_Seq sequence numbers of the two non-retransmitted RLP packets (one having a second largest SAR sequence number, and the other having a largest SAR sequence number) that, when the missing frame is detected, are received correctly by the wireless access terminal from carrier link 1 are 8 and 11.

After having determined the SAR_Seq sequence numbers of the two non-retransmitted RLP packets that are received correctly when the missing frame is detected (one having a second largest SAR sequence number, and the other having a largest SAR sequence number), the wireless access terminal assembles and sends a NAK control message to the network side. The NAK control message needs to contain the following information: the SAR_Seq sequence numbers, 8 and 11, of the two non-retransmitted RLP packets on carrier link 1 (one having a second largest SAR sequence number, and the other having a largest SAR sequence number) that, when the missing frame is detected, have been received by the wireless access terminal correctly.

Upon receiving the NAK control message, the network side determines the SAR_Seq sequence number range of the missing frame is from 9 to 10 according to the SAR_Seq sequence numbers 8 and 11. The network side determines an entry matching the SAR_Seq sequence number 8 and 11 in the RLP packet sending list stored locally, and determines the carrier link identification for the missing frame is carrier link 1.

The network side determines the entries in the RLP packet sending list stored locally that match the SAR_Seq sequence number 9 and 10. Because the RLP packet with the SAR_Seq sequence number of 10 is transmitted on carrier link 2, the carrier link identification in the entry matching the SAR_Seq sequence number 10 should be the identification of carrier link 2. Therefore, the identification, determined by the network side, of carrier link 1 on which the missing frame is transmitted is different from the carrier link identification in the entry matching the SAR_Seq sequence number 10, and the network side determines it is unnecessary to retransmit the RLP packet with the SAR_Seq sequence number of 10. Likewise, because the RLP packet with the SAR_Seq sequence number of 9 is transmitted on carrier link 1, the carrier link identification in the entry matching the SAR_Seq sequence number 9 should be the identification of carrier link 1. Therefore, the identification, determined by the network side, of carrier link 1 on which the missing frame is transmitted is identical to the carrier link identification in the entry matching the SAR_Seq sequence number 9, and determines the RLP packet with the SAR_Seq sequence number of 9 is the missing frame and should be retransmitted.

After having determined the RLP packet needed to be retransmitted, the network side retransmits the RLP packet with the SAR_Seq sequence number of 9 to the wireless access terminal. As a result, the challenge regarding stable forward data transmission based on RLP in a multi-carrier DO system is overcome.

It can be seen from example 4 that, in the present invention, to assemble the NAK control message, the wireless access terminal need not refer to the SAR_Seq sequence numbers of the RLP packets received from carrier link 2, but only need determine the SAR_Seq sequence numbers of the RLP packets received correctly from carrier link 1. As a result, the processing of a missing frame by the wireless access terminal is simplified. In the prior art, the NAK control message in example 2 contains the following information: the SAR_Seq sequence number, 9, of the missing RLP packet, the SAR_Seq sequence number, 11, of the last RLP packet received by the wireless access terminal from carrier link 1, and the SAR_Seq sequence number, 10, of the last RLP packet received by the wireless access terminal from carrier link 2; while in the present invention, the NAK control message contains the following information: the SAR_Seq sequence numbers of the two non-retransmitted RLP packets (one having a second largest SAR sequence number, and the other having a largest SAR sequence number) that, when the missing frame is detected, are received correctly by the wireless access terminal from carrier link 1. A SAR_Seq sequence number usually occupies 22 bits. In example 2 of the prior art, the NAK control message is of at least 66 bits; and in addition, as the number of the carrier links increases, the length of the NAK control message will increase in a unit of 22 bits. However, in the present invention, the NAK control message includes at least 44 bits, and the length is independent to the number of the carrier links. As a result, the technical solution in the present invention simplifies the NAK control message and improves the efficiency of payload transmission in a multi-carrier DO system.

In example 3 and 4, the SAR_Seq sequence number of an RLP packet is a packet sequence number. Of course, the SAR_Seq sequence number of an RLP packet may also be a byte sequence number, i.e. be denoted by the sequence number of the first byte in the RLP packet. From the sequence number of the first byte and the data length of the RLP packet, the SAR_Seq sequence number of the next RLP packet can be determined. For example, if the sequence number of the first data byte in an RLP packet is 0 and the data length of the RLP packet is 100, the SAR_Seq sequence number of the next RLP packet is 100. In that case, the SAR_Seq sequence numbers transmitted to the network side should be partial values among the SAR_Seq sequence numbers. For example, supposing the ARQ_Seq and SAR_Seq sequence numbers of the non-retransmitted RLP packets received correctly by the wireless access terminal from carrier link 1 are <1, 0> and <3, 200>, and the packet length of each RLP packet is 100, because the ARQ_Seq sequence numbers are not consecutive and the byte sequence numbers of the RLP data received correctly are 0˜99 and 200˜299, it can be determined that the RLP data with byte sequence numbers 100˜199 has missed, i.e. the RLP packet with ARQ_Seq and SAR_Seq sequence numbers of <2, 100> has missed. Therefore, the wireless access terminal determines there is a missing frame. In that case, the partial values among the SAR_Seq sequence numbers transmitted by the wireless access terminal to the network side, i.e. a combination of the SAR_Seq sequence numbers, should be any sequence number from 0 to 99 and any sequence number from 200 to 299. The network side determines the RLP packet needed to be retransmitted according to the received SAR_Seq sequence numbers and the packet length of the RLP packet, and retransmits the RLP packet with byte sequence numbers of 100˜199 to the wireless access terminal. Generally, the combination of the SAR_Seq sequence numbers may be chosen as a combination of the sequence numbers of the first bytes, like the combination of 0 and 200 in the above example.

A NAK-based data transmission unit retransmission system in a multi-link system provided in the present invention is shown in FIG. 2.

As shown in FIG. 2, the system provided in the present invention mainly includes: a data transmitter and a data receiver, the data receiver having a retransmission request unit, and the data transmitter having a retransmission unit. The data receiver may be a wireless access terminal; and accordingly, the data transmitter is at the network side. Hereunder the system provided in the present invention will also be described in conjunction with an example, in which the data receiver is a wireless access terminal, the data transmitter is the network side, the data transmission unit is a data frame, and the missing data transmission unit is a missing frame.

The retransmission request unit is mainly configured to determine, after having determined there is a NAK-based missing frame, the identification information of two of non-retransmitted data frames that, when the missing frame is detected, are received correctly from the carrier link on which the missing frame is transmitted, one having a second largest SAR sequence number among all non-retransmitted data frames that have been received correctly, and the other having a largest SAR sequence number, and transmit the identification information of the two non-retransmitted data frames to the retransmission unit.

The retransmission unit is mainly configured to determine the data frame needed to be retransmitted according to the received identification information, and retransmit the data frame to the retransmission request end. The major functions of the retransmission request end are implemented by a detection module, an identification information determination module, and a control message assembly module. The major functions of the retransmission unit are implemented by a data transmission unit retransmission determination module and a retransmission module.

The detection module is mainly configured to detect the carrier link-based sequence numbers of data frames received by the wireless access terminal from the carrier links, and, when determining the sequence numbers of data frames on a carrier link are not consecutive, determine there is a NAK-based missing frame and notify the identification information determination module. For example, supposing the ARQ_Seq sequence numbers of RLP packets received by the wireless access terminal from carrier link 1 are 1, 2, 3, and 5, the detection module determines there is a missing RLP packet.

The identification information determination module is mainly configured to determine the data frame sequence numbers of two of non-retransmitted data frames that, when the missing frame is detected, are received by the wireless access terminal correctly from the carrier link on which the missing frame is transmitted, one having a second largest SAR sequence number among all non-retransmitted data frames that have been received correctly, and the other having a largest SAR sequence number. For example, supposing the SAR_Seq sequence numbers of the two non-retransmitted RLP packets (one having a second largest SAR sequence number, and the other having a largest SAR sequence number) that, when the missing frame is detected, are received by the wireless access terminal from carrier link 1 are 8 and 11, the identification information determination module transmits the data frame sequence numbers of the above two non-retransmitted RLP packets to the control message assembly module.

The control message assembly module is mainly configured to assemble a NAK control message according to the received data frame sequence numbers of the two non-retransmitted RLP packets, and transmit the NAK control message to the data transmission unit retransmission determination module. For example, the SAR_Seq sequence numbers 8 and 11 are carried in the NAK control message to transmit to the data transmission unit retransmission determination module.

The data transmission unit retransmission determination module is mainly configured to determine the data frame sequence number range of the missing frame according to the received data frame sequence numbers, determine the carrier link identification information of the missing frame according to the received data frame sequence numbers and the data frame sending list stored locally, and then determine the carrier link identification information in each entry in the data frame sending list matching a data frame sequence number within the data frame sequence number range of the missing frame according to the data frame sending list stored locally, and, if the carrier link identification information of a matching entry is identical to the carrier link identification information of the missing frame, determine the missing frame is the data frame needed to be retransmitted, and transmit the data frame sequence number of the missing frame to the retransmission module. For example, supposing the carrier link corresponding to the RLP packet with a SAR_Seq sequence number of 10 in the data frame sending list is carrier link 2, and the carrier link corresponding to the RLP packet with a SAR_Seq sequence number of 9 in the data frame sending list is carrier link 1, because the information in the NAK control message is the SAR_Seq sequence numbers 8 and 11, the data frame sequence number range of the missing frame is determined as from 9 to 10, and the carrier link identification of the missing frame is determined as carrier link 1. Therefore, the RLP packet with the SAR_Seq sequence number of 9 is determined as the missing frame and should be retransmitted. The data transmission unit retransmission determination module transmits the SAR_Seq sequence number 9 to the retransmission module.

The retransmission module is mainly configured to retransmit the corresponding data frame to the wireless access terminal, according to the received data frame sequence number, e.g. SAR_Seq sequence number 9.

The transmitter and receiver provided in the present invention are as described in conjunction with the above system, and will not be described further.

Although the present invention has been described with reference to the above embodiments, those skilled in the art will recognize that it is possible to make a variety of modifications and variations to the present invention without departing from the scope of the present invention. For example, although the present invention is described in the above embodiments in conjunction with an example of a multi-carrier DO system, the technical solutions provided in the present invention is also applicable to other data transmission systems, except only that the names of the data transmitter, data receiver, data transmission unit, sequence number, and link may be slightly different. For example, in an interlace-based data transmission system, each interlace is a link; and the essential implementations are substantially the same. Therefore, the attached claims of the present invention cover such modifications and variations.

What is claimed is:

1. A method for data transmission unit retransmission, comprising the steps of:
determining, by a data receiver, that there is a Non-Acknowledgement-based missing data transmission unit;
transmitting, by the data receiver, identification information of data transmission units that have been received correctly from a same link on which the missing data transmission unit is transmitted, to a data transmitter; and
determining, by the data transmitter, the data transmission unit needed to be retransmitted according to the received identification information, and retransmitting the data transmission unit needed to be retransmitted.

2. The method according to claim 1, wherein the link is a carrier in a CDMA 2000 system.

3. The method according to claim 1, wherein the step of determining that there is a Non-Acknowledgement-based missing data transmission unit further comprises the step of:
upon detecting that sequence numbers of data transmission units received from a single link are inconsecutive, determining, by the data receiver, that the Non-Acknowledgement-based missing data transmission unit occurs.

4. The method according to claim 1, wherein the data transmission units that have been received correctly include two non-retransmitted data transmission units that have been received correctly when the missing data transmission unit is detected, one being a non-retransmitted data transmission unit of a penultimately received non-retransmitted data packet and having a largest SAR sequence number among all non-retransmitted data transmission units of the penultimately received non-retransmitted data packet, and the other being a non-retransmitted data transmission unit of a last received non-retransmitted data packet and having a smallest SAR sequence number among all non-retransmitted data transmission units of the last received non-retransmitted data packet.

5. The method according to claim 1, wherein the identification information of the correctly received data transmission units includes sequence numbers of the correctly received data transmission units assigned by the data transmitter, wherein the data transmitter assigns a consecutive sequence number for each of all data transmission units transmitted on all the links to the data receiver.

6. The method according to claim 1, wherein the step of transmitting identification information further comprises the steps of:
setting, by the data receiver, the identification information of the data transmission units received correctly in a control message, and transmitting the control message to the data transmitter, to request the data transmitter to retransmit the missing data transmission unit.

7. The method according to claim 3, wherein the step of transmitting identification information further comprises the steps of:
setting, by the data receiver, the identification information of the data transmission units received correctly in a control message, and transmitting the control message to the data transmitter, to request the data transmitter to retransmit the missing data transmission unit.

8. The method according to claim 4, wherein the step of transmitting identification information further comprises the steps of:
setting, by the data receiver, the identification information of the data transmission units received correctly in a control message, and transmitting the control message to the data transmitter, to request the data transmitter to retransmit the missing data transmission unit.

9. The method according to claim 5, wherein the step of transmitting identification information further comprises the steps of:
setting, by the data receiver, the identification information of the data transmission units received correctly in a control message, and transmitting the control message to the data transmitter, to request the data transmitter to retransmit the missing data transmission unit.

10. A system for data transmission unit retransmission, comprising:
a data receiver, and
a data transmitter,
wherein the data receiver includes a retransmission request unit and the data transmitter has a retransmission unit,
wherein the retransmission request unit is configured to determine, upon finding an occurrence of a Non-Acknowledgement-based missing data transmission unit, identification information of data transmission units that have been received correctly from a link on which the missing data transmission unit is transmitted and to transmit the identification information of the data transmission units received correctly to the retransmission unit; and
wherein the retransmission unit is configured to determine a data transmission unit needed to be retransmitted according to the identification information received from the retransmission request unit and retransmit the data transmission unit needed to be retransmitted to the data receiver.

11. The system according to claim 10, wherein the retransmission request unit comprises a detection module, an identification information determination module, and a control message assembly module, and wherein the retransmission unit comprises a retransmission determination module and a retransmission module,
wherein:
the detection module is configured to detect single-link-based sequence numbers of data transmission units received by the data receiver from a single link, to determine, upon finding that the data transmission unit sequence numbers assigned by the link are inconsecutive, the Non-Acknowledgement-based missing data transmission unit, and to notify the identification information determination module;
the identification information determination module is configured to determine, upon receiving the notification from the detection module, data transmission unit sequence numbers of two non-retransmitted data transmission units that, when the missing data transmission unit is detected, have been received correctly by the data receiver from the link on which the missing data transmission unit is transmitted, one being a non-retransmitted data transmission unit of a penultimately received non-retransmitted data packet and having a largest SAR sequence number among all non-retransmitted data transmission units of the penultimately received non-retransmitted data packet, and the other being a non-retransmitted data transmission unit of a last received non-retransmitted data packet and having a smallest SAR sequence number among all non-retransmitted data transmission units of the last received non-retransmitted data packet, and to transmit the data transmission unit sequence numbers of the two non-transmitted data transmission units to the control message assembly module;
the control message assembly module is configured to assemble a control message according to the data transmission unit sequence numbers of the two correctly received non-retransmitted data transmission units, the data transmission unit sequence numbers being set in the control message, and to transmit the control message to the data transmission unit retransmission determination module;
the retransmission determination module is configured to determine link identification information in an entry of a data transmission unit sending list stored locally matching the received data transmission unit sequence number, to determine the data transmission unit needed to be retransmitted according to the data transmission unit sending list, the link identification information, and the received identification information of the non-retransmitted data transmission units, and to transmit the data transmission unit sequence number of the data transmission unit needed to be retransmitted to the retransmission module; and
the retransmission module is configured to transmit the corresponding data transmission unit to the data receiver according to the received data transmission unit sequence number.

12. A data receiver, comprising a retransmission request unit,
wherein
the retransmission request unit is configured to determine, upon finding an occurrence of a Non-Acknowledgement-based missing data transmission unit, identification information of data transmission units that have been received correctly from a link on which the missing data transmission unit is transmitted, and to transmit the identification information of the data transmission units received correctly to a data transmitter so that the data transmitter can determine a data transmission unit needed to be retransmitted according to the identification information.

13. A data transmitter, comprising a retransmission unit, wherein
the retransmission unit is configured to determine a data transmission unit needed to be retransmitted according to identification information transmitted from a data receiver, and to retransmit the data transmission unit needed to be retransmitted to the data receiver,
wherein the identification information includes identification information of the data transmission units that have been received correctly from the link on which a missing data transmission unit is transmitted.

14. The method according to claim 1, wherein the data transmission units that have been received correctly include data transmission units from two non-retransmitted data packets that have been received correctly when the missing data transmission unit is detected, one being a non-retransmitted data packet having a second largest SAR sequence number among all non-retransmitted packets and the other having a largest SAR sequence number.
